(19) United States
(12) Patent Application Publication
(10) Pub. No.: US 2009/0038204 A1
(43) Pub. Date: Feb. 12, 2009

(54) PORTABLE CONTAINER MOUNTED COUNTER FOR FISHING, HUNTING, AND OTHER OUTDOOR ACTIVIES

(76) Inventor: Gary J. Duszynski, Delavan, WI (US)

Correspondence Address: GEHRKE & ASSOCIATES, S.C., 123 N. 86th ST, WAUWATOSA, WI, 53226, US

(21) Appl. No.: 11/933,064

(22) Filed: Oct. 31, 2007

Related U.S. Application Data
(63) Continuation-in-part of application No. 11/837,194, filed on Aug. 10, 2007.

(51) Int. Cl. A01M 31/00

(52) U.S. Cl. 43/1

(57) ABSTRACT

A device for electronically and optically counting objects, such as fish, animals, vegetation or other materials, as they are placed into a container. As objects are placed into the container, they lower a flap or flaps and fall through the opening to the container. A light source, such as a laser or LED, is directed toward a light detector in such a way as to be disrupted by the flap (s) as the animal falls into the container. A light detector detects said disruption of the light and signals the electronic circuit to add to the number previously counted. A light spring or similar mechanical energy storage element returns the flap or flaps to the original position. Various methods of communicating the count are provided. The preferred method of communicating the count is via an integrated visual display. The preferred method of powering the device is by the use of one or more electric battery. Various methods of electrically powering the device are provided.

### CROSS REFERENCE TO RELATED APPLICATION

This application is a Continuation in Part Application of U.S. patent application Ser. No. 11/837,194 filed on Aug. 10, 2007. This application is herein incorporated by reference.

### BACKGROUND OF THE INVENTION

1. Field of Invention

This invention relates to counters for fishing, hunting or camping.

2. Discussion of Relevant Prior Art

As any experienced outdoorsman knows, keeping track of the number of animals one has caught while fishing, hunting or otherwise collecting materials can be important. Aside from a general desire to know how many animals one has caught, often, there are legal limits on the number of animals a person may harvest. It can be difficult over a long period of time to accurately recall the number of animals caught and retained, especially when some are released and not retained. As more animals are caught and retained, manually counting becomes increasing difficult, as the animals, if alive, are moving.

While there are existing devices for counting fish, these devices are deficient in many ways. For instance, there are fish counters designed to count fish in a large-scale commercial setting like fish farming or bait stores. These counters are not designed to be portable and typically require that the fish be a fairly uniformed size since these systems often require the fish to swim or be moved past a detector in a tube or channel. These fish counting systems are relatively complex and are not designed to provide portable counting.

There are some portable fish counters that rely upon a mechanical trigger for the counting system. However, counting systems that demand that a fish be forced to trigger the counter by physical contact with a flap or paddle do not address the variety of sizes one may encounter while fishing and the slippery and agitated state of a fish when caught. A fish that is thrashing and trying to return to the water may take advantage of this physical contact to push itself and resist retention. Using an optically triggered counter allows the fish to be dropped into the container without encountering significant resistance that could impede its downward movement.

There are fish counters designed to be placed on a cooler. However, these counters are not automatic and require that a button be pressed to account for each fish placed in the container. This system is inconvenient for the fisherman and open to inaccuracies if he or she forgets whether the button has been pushed.

### BRIEF SUMMARY OF THE INVENTION

The present invention is directed to a portable counter. It is object of this invention to provide a portable device for counting harvested or captured objects such as fish, fowl, vegetation or other materials and to provide a fast, reliable, and accurate device for counting animals as they are placed in a container and to communicate to the user the number thereof retained in the container. The forgoing object is met, in accordance with the present invention, by the provision of a device that monitors light, which is interrupted when an object, such as an animal, is dropped onto a flap that in turn moves through the light beam. The interruptions are in turn counted and relayed to the user.

Accordingly, it is the object of this invention to automatically count objects such as fish, animals, vegetation or other materials as they are placed into a portable container, such as a cooler or live well on a boat.

The foregoing and other objects and advantages of the invention will be set forth in or will be apparent from the following description and drawings.

### BRIEF DESCRIPTION OF THE DRAWINGS

FIG. 1 is a view of the counter as integrated into the top of a container.

FIG. 2 shows a side cut-away view of a fish, used as an example, dropping into the container and causing the flaps to interrupt the light beam generated by the counter.

FIG. 3 shows a single flap embodiment of the counter.

FIG. 4 shows a multiple flap embodiment of the counter with a communication center and cable for external power.

FIG. 5 shows a cut-away view of the essential electronic elements of the counter.

FIG. 6 shows an alternative embodiment of the counter having a cut-away view of the essential electronic elements of the counter including fiber optic strands to both transmit light from the light source and receive light and transmit it to the light detector.

### DETAILED DESCRIPTION OF THE INVENTION

The following description of preferred embodiments is merely exemplary in nature and is in no way intended to limit the invention, its application or uses.

The portable counter is comprised of at least one light source, at least one light detector, at least one flap, at least one spring, an electronic counting circuit, and an electric power source external power source connector. And alternative embodiment may utilize optical fibers to transmit light. The portable counter may be manufactured as part of a container lid or as a unit that can be mounted on an existing container or as part of its lid.

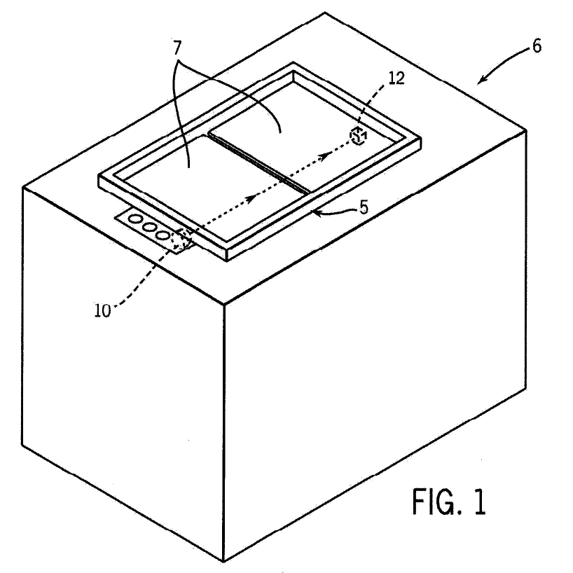

As shown in FIG. 1, the portable counter (6) is in such a position as to allow the light from the light source (10) to transmit across the container opening (5) and be detected by at least one light detector (12) when the flaps (7) are in an up position. The light source (10) and light detector (12) must be attached to a semi-rigid to rigid surface to prevent excessive movement and maintain functioning orientation.

The light source (10) for the device is an electrically powered light emitter. The light emitted must be of a wavelength as to allow detection in ambient light conditions, or modulated in such a way as to allow detection in ambient light conditions. It is desirable that power consumption of the light source (10) be low so as to allow the device to operate over long periods of time. Although other types of light sources may function, it is anticipated that the device would utilize light-emitting diode(s) or laser diode(s).

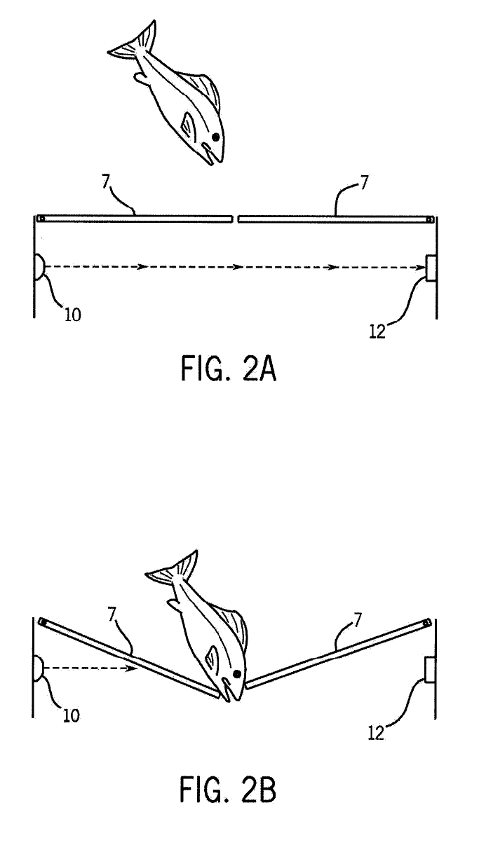

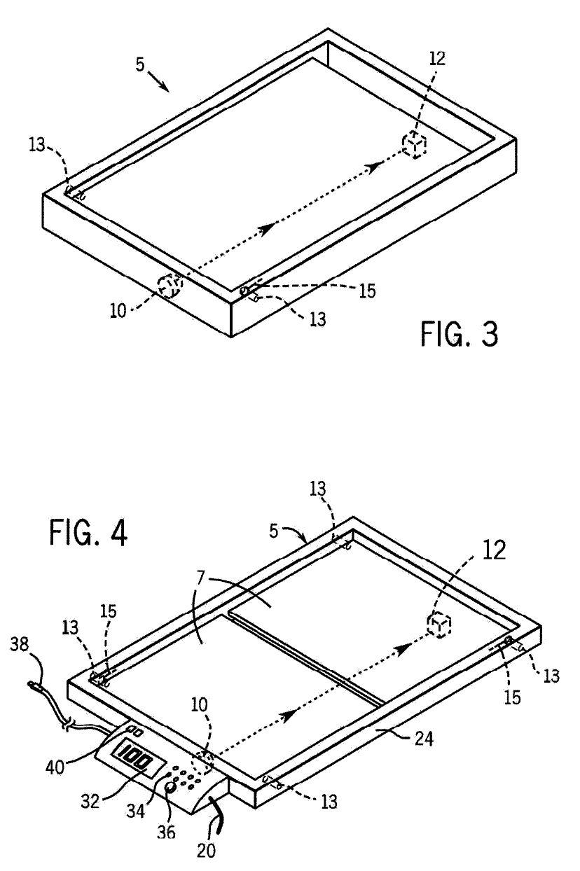

The light detector (12) is a photodiode or photoelectric sensor that receives the light from the light source (10). When an object falls, it comes into contact with a flap or flaps (7) moving the flap or flaps (7) downward. This, in turn, interrupts the light beam and the changed is detected. FIG. 2 is a side cut-away view of an object falling into the container and the flap interrupting the light beam. The passage of an object into the container will change the amount of light moving from the light source (10) to the light detector (12). The change in amount of light received by the light detector (12) is in turned received by the electronic circuit.

Referring now to FIG. 4, the flap or flaps (7) may be made of plastic, metal, hard rubber, or any other rigid to semi-rigid material that can hold its shape. In the single flap embodiment, the flap (7) rests within the container opening (5) and above the beam of light generated by the light source (10). The flap is held in position by a light spring (15) or similar mechanical energy storage element. The flap is connected to the container opening (5) by a hinge (13) or similar pivoting connection. The flap must be at least of a size that when pushed downward, it is capable of interrupting the light beam moving from the light source (10) to the light detector (12). The flap (7) is moved downward when an object is dropped into the container. The flap (7) is then returned to their resting position by the light spring or similar mechanical energy storage element. More than one spring (15) or similar mechanical energy storage element may be used, but at least one is necessary.

In the multiple flap embodiment, the flaps (7) rest within the container opening (5) and above the beam of light generated by the light source (10). The flaps (7) are held in position by a light spring or similar mechanical energy storage element. The flaps (7) are connected to container opening (5) by a hinges or similar pivoting connections (13). The flaps (7) must be at least of a size that when pushed downward, they are capable of interrupting the light beam moving from the light source (10) to the light detector (12) and they must not interfere with the free movement of the other flaps. The flaps (7) are moved downward when an object is dropped into the container. The flaps (7) are then returned to their resting position by the light springs or similar mechanical energy storage elements.

The electronic counting circuit is any electronic circuit capable to monitoring the light detector for changes, adding one to a count retained in memory when the pre-defined change occurs. There are many circuits know to the art that are capable of this function. In addition to the basic counting circuit, additional electronic features are included in other embodiments to enhance the basic functioning of the counter. These might include, but are not limited to, long-term storage memory like various magnetic memory media know to the art. This combined with a clock and calendar circuit would allow on ongoing record of objects caught from day to day. In addition, it is desirable that the electronic circuit be able to retain a count despite the removal of the power supply.

FIG. 4 shows an embodiment of the counter mounted on a frame (24) which can then be mounted on a container. The light source (10) and light detector (12) are positioned on the inside edge of the frame (24). A liquid crystal or LED visual display (32) communicates the count allowing a person to see a number indicating the number of items that have been placed in a container. In addition to a visual display (32), other ways of communicating the count may be desirable. For example, a speaker (34) may be provided to allow the use of synthetic human voice, or an audible series of tones may be used. Also, wireless and infrared communication (36) would allow electronic devices to receive the information, allowing for the integration of commonly used electronic devices like sonar or GPS. A data cable (38) may also be provided to allow wired communication with such electronic devices. A button (40) would also be provided to restart the count or to correct any errors in the count or allow removal of an object from the container. An external power source may be connected using a power cable (20).

The internal electric power source is any compact and portable battery, fuel cell, generator, or capacitor that is capable to supplying electrical energy to the device. Preferably, this would be a pre-charged chemical battery. However, in the embodiment of the device that allows for an external power source, an internal electric power source could be omitted or could be charged so as to allow disconnection from the external power source.

The external power source could either serve as the only power source for the device or could charge or supplement the device's internal electrical power source. A common example would be a 12-Volt battery available on many cars and fishing boats. Alternative external powers supplies include, but are not limited to, solar panels, household alternating currents, accessory plugs on vehicles, and wind turbines. Some of external power sources could also be integrated into the container along with the device, solar for instance, to serve to extend the power of the internal power source.

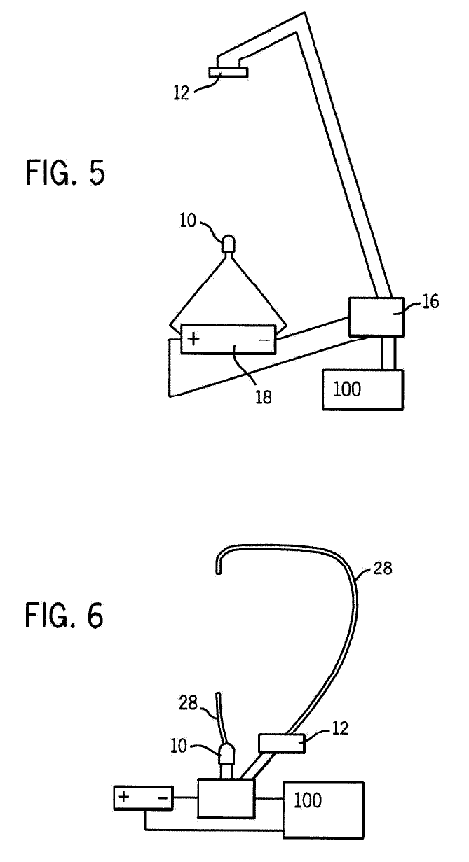

FIG. 5 is a cut-away view of the relationships between essential electronic elements of the device in its preferred embodiment. The power source (18) powers both the light source (10) and the electronic circuit (16). The electronic circuit (16) monitors the light detector (12) and keeps track of the count. In FIG. 6, the essential electronic elements of the device in an alternative embodiment include fiber optic strands (28) to both transmit light from the light source (10) and receive light and transmit it to the light detector (12). This allows either the light detector (12) or the light source (10) or both to remain closer to the main electrical circuit (16).

The lid of the container may act as the housing, an enclosure for the components of the counter. However, in alternative embodiments, a housing separate from the lid may be used. The housing or lid is made of a rigid plastic, metal or similar material. It is designed to protect the components from water, sand and other damaging elements. It also serves to secure the components in their positions within the device and to present the user with a simple interface. The housing or lid allows access for replacement of batteries or similar internal power supply. Depending on the particular embodiment, the housing may have openings for a communication cable, a speaker, an infrared port, and an external power supply.

I claim:

1. A portable counter comprising:
a light source, a light detector aligned to detect light from said source, at least one flap, at least one mechanical energy storage element, such as a spring, an electronic counting circuit to count the number of disruptions of the light emitted from said light source to said light detector, a visual display to communicate the count from said electronic counting circuit, and a power source.

2. The portable counter of claim 1, wherein the power source is a solar panel.

3. The portable counter of claim 1, wherein the electronic circuit communicates the count to external electronic devices.

4. The portable counter of claim 1, wherein the electronic circuit communicates the count audibly with either a repeated tone or synthetic or recorded voice.

5. The portable counter of claim 1, wherein the power source is an external DC or AC supply.

6. The portable counter of claim 1, further comprising a form of data storage.

7. The portable counter of claim 1, further comprising at least one button to allow addition or subtraction to the count.

8. A portable counter comprising:
a frame through which objects may be dropped, a light source, a light detector to detect light from said source, at least one flap, at least one mechanical energy storage element, such as a spring, an electronic counting circuit to count the number of disruptions of the light emitted from said light source to said light detector, and a visual display to communicate the count from said electronic counting circuit and a power source.

9. The portable counter of claim 8, wherein the power source is a solar panel.

10. The portable counter of claim 8, wherein the electronic circuit communicates the count to external electronic devices.

11. The portable counter of claim 8, wherein the electronic circuit communicates the count audibly with either a repeated tone or synthetic or recorded voice.

12. The portable counter of claim 8, wherein power source is an external DC or AC supply.

13. The portable counter of claim 8, further comprising a comprising a form of data storage.

14. The portable counter of claim 8, further comprising at least one button to allow addition or subtraction to the count.

15. A portable counter comprising:
a container opening through which objects are dropped into the container, a light source, a light detector positioned on the frame to detect light from said source, at least one flap, at least one mechanical energy storage element, such as a spring, an electronic counting circuit to count the number of disruptions of the light emitted from said light source to said light detector, a means to communicate the count from said electronic counting circuit to a separate electronic device and a power source to provide power to said light source, light detector, electronic counting circuit and the visual display.

16. The portable counter of claim 15, wherein the power source is a solar panel.

17. The portable counter of claim 15, wherein the electronic circuit communicates the count audibly with either a repeated tone or synthetic or recorded voice.

18. The portable counter of claim 15, wherein power source is an external DC or AC supply.

19. The portable counter of claim 15, further comprising a comprising a form of data storage.

20. The portable counter of claim 15, further comprising at least one button to allow addition or subtraction to the count.
